(19) United States
(12) Patent Application Publication
(10) Pub. No.: US 2006/0079609 A1
(43) Pub. Date: Apr. 13, 2006

(54) Heat curable resin composition having a low elastic modulus, heat curable film using same, and cured products

(75) Inventors: Takashi Nishioka, Chuo-ku (JP); Hirofumi Goto, Chuo-ku (JP); Katsumi Inomata, Chuo-ku (JP); Shin-ichirou Iwanaga, Chuo-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JSR Corporation, Chuo-ku (JP)

(21) Appl. No.: 11/280,328

(22) Filed: Nov. 17, 2005

(30) Foreign Application Priority Data
Jul. 17, 2003 (JP) 2003-275944

(51) Int. Cl. C08L 63/00

(52) U.S. Cl. 523/400

(57) ABSTRACT

A heat curable resin composition having a low elastic modulus comprising (A) an epoxy resin, (B) crosslinked fine particles, and (C) a curing agent, which when cured with heat, produces a cured product having a elastic modulus of less than 1 GPa is provided. A cured product excelling in characteristics such as stress relaxation property (low stress properties), electric insulation properties, heat shock resistance, and heat resistance can be produced from the heat curable resin.

### BACKGROUND OF THE INVENTION

1. Technical Field

The present invention relates to a heat curable resin composition having a low elastic modulus, heat curable film using this composition, and their cured products. More particularly, the present invention relates to a heat curable resin composition having a low elastic modulus in which an epoxy resin is used, a heat curable film using this composition, and a cured product obtainable by curing the composition or the film with heat. The present invention also relates to electronic components having a stress relaxation layer formed using this heat curable resin composition having a low elastic modulus.

2. Background Art

In recent years, reduction in size and weight, as well as high-density packaging, are demanded for semiconductors used for personal digital assisting instruments such as notebook PCs, cellular phones, and mobile computing devices. To satisfy this demand, a chip-size package (CSP) with a size equivalent to the semiconductor device itself has been intensively developed.

Many types of CSPs have been proposed. A most commonly used CSP has a first insulation resin layer formed by removing an electrode exposed on the surface of a semiconductor circuit and is provided with an electrically connected wiring extending from the electrode. A metal post is formed on the extended wiring. A second insulation resin layer is formed so that the surface of the metal post may be exposed. A major part of the semiconductor circuit is sealed with an epoxy resin or the like. After sealing with a resin, a solder ball is provided on the exposed area of the metal post.

This semiconductor device is connected with external connection terminals of substrates such as a printed circuit board via the solder ball. In this instance, if the thickness of the semiconductor device is reduced to its smallest possible size by using a resin to act both as the second insulation resin layer and the sealing resin taking the manufacturing cost into consideration, the semiconductor device may easily produce cracks and circuit wire breakage due to heat stress and moisture adsorption. Because the coefficient of thermal expansion of the substrate greatly differs from that of the semiconductor device, a stress is concentrated on the solder ball connecting these two parts. This stress induces cracks in the insulation resin layer and the interface of the insulated resin layer and metal post. Cracks and circuit wire breakage also occur by corrosion of wiring due to water adsorption.

Japanese Patent Application Laid-open No. 2001-123044 discloses an insulated resin composition for printed circuit boards comprising an epoxy resin, epoxy resin curing agent, curing promoter, and core-shell structure crosslinking rubber. The applicant claims that the cured product of the resin composition exhibits excellent heat resistance and excellent adhesion to copper.

In view of the above problems in the prior art technologies, the present invention has an object of providing a cured product excelling in characteristics such as stress relaxation properties (low stress properties), electrical insulation properties, heat shock resistance, and heat resistance, and a heat curable resin composition having a low elastic modulus which can produce such a cured product. Another object of the present invention is to provide highly reliable electronic components free from cracks, circuit wiring breakage, and the like due to heat stress from the heat curable resin composition having a low elastic modulus.

### SUMMARY OF THE INVENTION

As a result of extensive studies to achieve the above objects, the inventors of the present invention have found that a heat curable resin composition having a low elastic modulus which can produce a cured product with a elastic modulus of less than 1 GPa can produce a product excelling in characteristics such as stress relaxation properties (low stress properties), electrical insulation properties, heat shock resistance, and heat resistance, and being free from cracks, circuit wiring breakage, and the like due to heat stress.

Specifically, the heat curable resin composition having a low elastic modulus of the present invention comprises (A) an epoxy resin, (B) crosslinked fine particles, and (C) a curing agent, which, when cured with heat, can produce a cured product with a elastic modulus of less than 1 GPa.

The crosslinked fine particles (B) are preferably incorporated in the composition in an amount of 50 parts by weight or more for 100 parts by weight of the epoxy resin (A) and have a single glass transition temperature of between −100° C. and 0° C. The crosslinked fine particles (B) are preferably made of a copolymer of a crosslinkable monomer (b1) having at least two polymerizable unsaturated bonds.

The heat curable film of the present invention is formed using the above curable resin composition having a low elastic modulus.

The heat curable product of the present invention can be obtained by curing the above curable resin composition having a low elastic modulus with heat.

The electronic components of the present invention have a stress relaxation layer formed using the above curable resin composition having a low elastic modulus.

### BRIEF DESCRIPTION OF THE DRAWINGS

FIG. 1 is a cross-sectional view of a substrate used for the test of heat shock resistance in the examples.

FIG. 2 is a top view of the substrate used for the test of heat shock resistance in the examples.

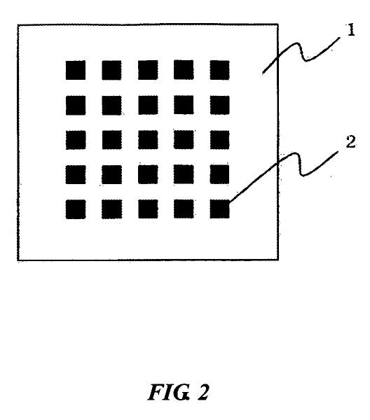

### DETAILED DESCRIPTION OF THE INVENTION AND PREFERRED EMBODIMENTS

<Heat Curable Resin Composition Having a Low Elastic Modulus>

The heat curable resin composition having a low elastic modulus of the present invention comprises (A) an epoxy resin, (B) crosslinked fine particles, and (C) a curing agent. The heat curable resin composition having a low elastic modulus may also contain an organic solvent, inorganic filler, adhesion assistant, other additives, and the like if required.

The components used in the present invention will now be described.

(A) Epoxy Resin

There are no specific limitations to the epoxy resin (A) used in the present invention insofar as the epoxy resin can be used for an interlayer dielectric film and flattening film for multilayer circuit boards, and as an overcoat, electrical insulation film, and the like for electronic components. Specific examples include bisphenol A epoxy resin, bisphenol F epoxy resin, hydrogenated bisphenol A epoxy resin, hydrogenated bisphenol F epoxy resin, bisphenol S epoxy resin, brominated bisphenol A epoxy resin, biphenyl epoxy resin, naphthalene epoxy resin, fluorene epoxy resin, spirocyclic epoxy resin, bisphenol alkane epoxy resin, phenol novolak epoxy resin, o-cresol novolak epoxy resin, brominated cresol novolak epoxy resin, trishydroxymethane epoxy resin, tetraphenylolethane epoxy resin, aliphatic epoxy resin, alcohol epoxy resin, butyl glycidyl ether resin, phenyl glycidyl ether resin, cresyl glycidyl ether resin, nonyl glycidyl ether resin, diethylene glycol diglycidyl ether resin, polyethylene glycol diglycidyl ether resin, polypropylene glycol diglycidyl ether resin, glycerol polyglycidyl ether resin, neopentyl glycol diglycidyl ether resin, 1,6-hexanediol diglycidyl ether resin, trimethylolpropane triglycidyl ether resin, hexahydrophthalic acid diglycidyl ether resin, fatty acid modified epoxy resin, toluidine epoxy resin, aniline epoxy resin, aminophenol epoxy, 1,3-bis(N,N-diglycidylaminomethyl)cyclohexane resin, hydantoin epoxy resin, triglycidylisocyanurate resin, tetraglycidyldiaminodiphenylmethane resin, diphenyl ether epoxy resin, dicyclopentadiene epoxy resin, dimmer acid diglycidyl ester resin, hexahydrophthalic acid diglycidyl ester resin, dimmer acid diglycidyl ether resin, silicone-modified epoxy resin, silicon-containing epoxy resin, urethane-modified epoxy resin, NBR-modified epoxy resin, CTBN-modified epoxy resin, epoxidated polybutadiene resin, and the like.

(B) Crosslinked Fine Particles

The crosslinked fine particles (B) used in the present invention have a single glass transition temperature (Tg) of between −100° C. and 0° C., and preferably between −80° C. and −20° C. Such crosslinked fine particles (B) are preferably made of a copolymer of a crosslinkable monomer having at least two polymerizable unsaturated bonds (hereinafter referred to as “crosslinkable monomer”) and a monomer other than the crosslinkable monomer (hereinafter referred to as “other monomer”), wherein the other monomer is selected from monomers that can produce a copolymer with a Tg of between −100° C. and 0° C. As more preferable other monomers, a monomer having a functional group which does not contain a polymerizable unsaturated bond, such as a carboxyl group, epoxy group, amino group, isocyanate group, and hydroxyl group, can be given.

As specific crosslinkable monomers, compounds having at least two polymerizable unsaturated bonds such as divinylbenzene, diallyl phthalate, ethylene glycol di(meth)acrylate, propylene glycol di(meth)acrylate, trimethylolpropane tri(meth)acrylate, pentaerythritol tri(meth)acrylate, polyethylene glycol di(meth)acrylate, polypropylene glycol di(meth)acrylate, and the like can be given. Of these, divinylbenzene is preferable.

As specific examples of the other monomers, vinyl compounds such as butadiene, isoprene, dimethyl butadiene, and chloroprene; unsaturated nitrile compounds such as 1,3-pentadiene, (meth)acrylonitrile, α-chloroacrylonitrile, α-chloromethyl acrylonitrile, α-methoxy acrylonitrile, α-ethoxy acrylonitrile, crotonic acid nitrile, cinnamic acid nitrile, itaconic acid dinitrile, maleic acid dinitrile, and fumaric acid dinitrile; unsaturated amides such as (meth)acrylamide, N,N′-methylenebis(meth)acrylamide, N,N′-ethylenebis(meth)acrylamide, N,N′-hexamethylenebis (meth)acrylamide, N-hydroxymethyl(meth)acrylamide, N-(2-hydroxyethyl)(meth)acrylamide, N,N′-bis(2-hydroxyethyl)(meth)acrylamide, crotonic acid amide, and cinnamic-acid amide; (meth)acrylic acid esters such as methyl (meth)acrylate, ethyl (meth)acrylate, propyl (meth)acrylate, butyl (meth)acrylate, hexyl (meth)acrylate, lauryl (meth)acrylate, polyethylene glycol (meth)acrylate, and polypropylene glycol (meth)acrylate; aromatic vinyl compounds such as styrene, α-methylstyrene, o-methoxystyrene, p-hydroxystyrene, and p-isopropenyl phenol; epoxy (meth)acrylates obtained by the reaction of diglycidyl ether of bisphenol A, diglycidyl ether of glycol, or the like with (meth)acrylic acid, hydroxy alkyl(meth)acrylate, or the like; urethane (meth)acrylates obtained by the reaction of hydroxy alkyl (meth)acrylate with polyisocyanate; epoxy group-containing unsaturated compounds such as glycidyl (meth)acrylate and (meth)allyl glycidyl ether; unsaturated acid compounds such as (meth)acrylic acid, itaconic acid, β-(meth)acryloxyethyl succinate, β-(meth)acryloxyethyl maleate, β-(meth)acryloxyethyl phthalate, and β-(meth)acryloxyethyl hexahydrophthalate; amino group-containing unsaturated compounds such as dimethylamino (meth)acrylate and diethylamino (meth)acrylate; amide group-containing unsaturated compounds such as (meth)acrylamide and dimethyl (meth)acrylamide; hydroxyl group-containing unsaturated compounds such as hydroxyethyl (meth)acrylate, hydroxypropyl (meth)acrylate, and hydroxybutyl (meth)acrylate; and the like can be given.

Among these, butadiene, isoprene, (meth)acrylonitrile, alkyl (meth)acrylates, styrene, p-hydroxystyrene, p-isopropenyl phenol, glycidyl (meth)acrylate, (meth)acrylates, hydroxy alkyl(meth)acrylates, and the like are preferable.

In the present invention, the crosslinking monomers are used in an amount of preferably 1-20 wt %, and more preferably 2-10 wt % of the total amount of monomers used in the production of the crosslinked fine particles.

There are no specific limitations to the method of producing the crosslinked fine particles (B). For example, the emulsion polymerization method can be used. In the emulsion polymerization method, monomers containing crosslinkable monomers are emulsified in water using a surfactant. As an initiator, a radical polymerization initiator such as a peroxide catalyst or a Redox catalyst is added. A molecular weight modifier such as a mercaptan compound or a halogenated hydrocarbon is added, if necessary. The polymerization is carried out at 0-50° C. and, after reaching a predetermined polymerization conversion rate, terminated by adding a reaction termination agent such as N,N-diethylhydroxylamine. The crosslinked fine particles (B) are obtained by removing unreacted monomers from the polymerization reaction mixture by steam distillation or the like.

There are no specific limitations to the surfactant insofar as the surfactant can produce crosslinked fine particles (B) by emulsion polymerization. As examples, anionic surfactants such as alkyl naphthalene sulfonate and alkyl benzenesulfonate; cationic surfactants such as alkyl trimethylammonium salt and dialkyl dimethylammonium salt; nonionic surfactants such as polyoxyethylene alkyl ether, polyoxyethylene alkyl allyl ether, polyoxyethylene fatty acid ester, polyoxyethylene sorbitan fatty acid ester, and fatty acid monoglyceride; amphoteric surfactants; and reactive emulsifying agent can be given. The surfactants may be used either individually or in combination of two or more.

It is also possible to obtain solid crosslinked fine particles (B) by coagulating a latex containing the crosslinked fine particles (B) obtained by the emulsion polymerization using a salting-out process or the like, followed by washing and drying. In addition to salting out, crosslinked fine particles (B) prepared by using a nonionic surfactant can be coagulated by heating the latex to a temperature above the cloud point of the nonionic surfactant. In the case in which a surfactant other than a nonionic surfactant is used, it is possible to coagulate the crosslinked fine particles (B) by adding a nonionic surfactant after the polymerization and heating the latex to a temperature above the cloud point.

As the method for producing crosslinked fine particles without using a crosslinkable monomer, a method of adding a crosslinking agent such as a peroxide to a latex and crosslinking latex particles, a method of effecting gelatinization in latex particles by increasing the polymerization conversion rate, a method of effecting crosslinking within latex particles making use of functional groups such as a carboxyl group by adding a crosslinking agent such as a metal salt, and the like can be given.

The size of the crosslinked fine particles (B) used in the present invention is usually 30-500 nm, and preferably 40-200 nm. Although there are no specific limitations to the method for controlling the particle size of the crosslinked fine particles, when the crosslinked fine particles are prepared by emulsion polymerization, for example, the particle size can be controlled by controlling the number of micelles during the emulsion polymerization by adjusting the amount of the emulsifying agent to be used.

The crosslinked fine particles (B) are incorporated in the heat curable resin composition of the present invention in an amount of 30-120 parts by weight, and preferably 50-100 parts by weight for 100 parts by weight of the epoxy resin (A). If the amount incorporated is less than above smallest amount, the cured film obtained by curing the heat curable resin composition having a low elastic modulus has a elastic modulus exceeding 1 GPa; if more than the largest amount, the mutual solubility of the heat curable resin composition having a low elastic modulus with other components may decrease.

(c) Curing Agent

There are no specific limitations to the curing agent used in the present invention. As examples, amines, carboxylic acids, acid anhydrides, dicyandiamides, dibasic acid dihydrazide, imidazoles, organic boron, organic phosphine, guanidines, and their salts can be given. These curing agents can be used either individually or in combination of two or more.

The curing agent (C) is added to the heat curable resin composition of the present invention in an amount of 0.1-20 parts by weight, and preferably 0.5-10 parts by weight for 100 parts by weight of the epoxy resin (A). If required, a curing promoter can also be used together the curing agent (C) to promote the cure reaction.

(D) Organic Solvent

In the present invention, an organic solvent can be used, as required, to improve handling properties or to adjust the viscosity and storage stability of the heat curable resin composition having a low elastic modulus. There are no specific limitations to the types of organic solvents used in the present invention. As examples, ethylene glycol monoalkyl ether acetates such as ethylene glycol monomethyl ether acetate and ethylene glycol monoethyl ether acetate; propylene glycol monoalkyl ethers such as propylene glycol monomethyl ether, propylene glycol monoethyl ether, propylene glycol monopropyl ether, and propylene glycol monobutyl ether; propylene glycol dialkyl ethers such as propylene glycol dimethyl ether, propylene glycol diethyl ether, propylene glycol dipropyl ether, and propylene glycol dibutyl ether; propylene glycol monoalkyl ether acetates such as propylene glycol monomethyl ether acetate, propylene glycol monoethyl ether acetate, propylene glycol monopropyl ether acetate, and propylene glycol monobutyl ether acetate; cellosolves such as ethyl cellosolve and butyl cellosolve; carbitols such as butyl carbitol; lactic acid esters such as methyl lactate, ethyl lactate, n-propyl lactate, and isopropyl lactate; aliphatic carboxylic acid esters such as ethyl acetate, n-propyl acetate, isopropyl acetate, n-butyl acetate, isobutyl acetate, n-amyl acetate, isoamyl acetate, isopropyl propionate, n-butyl propionate, and isobutyl propionate; other esters such as methyl 3-methoxypropionate, ethyl 3-methoxypropionate, methyl 3-ethoxypropionate, ethyl 3-ethoxypropionate, methylpyruvate, and ethyl pyruvate; aromatic hydrocarbons such as toluene and xylene; ketones such as 2-heptanone, 3-heptanone, 4-heptanone, and cyclohexanone; amides such as N-dimethylformamide, N-methylacetamide, N,N-dimethyl acetamide, and N-methylpyrrolidone; and lactones such as γ-butyrolactone can be given.

These organic solvents may be used either individually or in combination of two or more.

(B) Other Resins:

The heat curable resin composition having a low elastic modulus, when necessary, may comprise a thermoplastic or heat curable resin such as a resin comprising a phenolic hydroxyl group, polyimide, acrylic polymer, polystyrene resin, polyolefin elastomer, styrene butadiene elastomer, silicon elastomer, a resin comprising a diisocyanate compound such as tolylene diisocyanate or the block compound thereof, a high density polyethylene, medium density polyethylene, polypropylene, polycarbonate, polyallylate, polyamide, polyamide imide, polysulfone, polyether sulfone, polyether ketone, polyphenylene sulfide, (denatured) polycarbodiimide, polyether imide, polyester imide, denatured polyphenylene oxide, or a resin comprising oxetane group. These resins can be appropriately used insofar as the effect of the present invention is not impaired.

These resins are preferably used when a large amount of the crosslinked fine particles (B) are used, for example, when preparing a low elastic heat curable resin composition using 70 parts by weight or more and preferably 80-120 parts by weight of the crosslinked fine particles (B) for 100 parts by weight of the epoxy resin (A). As a result, a cured film with even more excellent heat resistance can be obtained.

(F) Other Additives

The heat curable resin composition having a low elastic modulus obtained in the present invention, when necessary, may comprise an inorganic filler, adhesive adjuvant, polymer additive, reactive diluent, leveling agent, wettability improver, surfactant, plasticizer, antioxidant, antistatic agent, inorganic filler, fungicide, humidity adjusting agent, flame retardant, and the like. These additives can be used insofar as the effect of the present invention is not impaired.

(Heat Curable Resin Composition Having a Low Elastic Modulus)

The heat curable resin composition having a low elastic modulus of the present invention contains at least the epoxy resin (A), crosslinked fine particles (B), and curing agent (C), and when cured with heat, produces a cured product excelling in stress relaxation properties, electrical insulation properties, heat shock resistance, and heat resistance.

The heat curable resin composition having a low elastic modulus of the present invention is especially useful as an interlayer dielectric and flattening film in multilayer circuit boards for semiconductor devices, protective coating and electrical insulation layer for various types of electrical instruments and components, and a capacitor film. The heat curable resin composition having a low elastic modulus can also be suitably used in IC package materials, underfill materials, and liquid-crystal sealing materials.

The heat curable resin composition having a low elastic modulus of the present invention can also be prepared in the form of a powder or pellet and used in a heat curable forming material.

The heat curable resin composition having a low elastic modulus of the present invention can also be impregnated in a glass cloth and formed into a prepreg, which can be used in laminating materials such as copper-clad lamination. The prepreg can be prepared by impregnating the glass cloth with the heat curable resin composition having a low elastic modulus as is or the heat curable resin composition having a low elastic modulus can be mixed with a solvent to form a solution followed by impregnating the glass cloth with the solution.

<Heat Curable Film>

The heat curable film of the present invention can be obtained by, for example, coating a support, which has been previously treated for ease of mold releasing, with the heat curable resin composition having a low elastic modulus to form a heat curable film, wherein the heat curable film is separated from the support without being heat cured. The obtained heat curable film can be used as a low stress adhesive film for electrical instruments and components.

There are no specific limitations to the support used in the present invention. Examples include various metals such as iron, nickel, stainless steel, titanium, aluminum, and copper, as well as alloys of these metals; ceramics such as silicon nitride, silicon carbide, sialon, aluminum nitride, boron nitride, boron carbide, zirconium oxide, titanium oxide, alumina, and silica, as well as mixtures of these ceramics; semiconductors such as Si, Ge, SiC, SiGe, and GaAs; ceramic industry materials such as glass and potteries; and heat resistance resins such as aromatic polyamide, polyamideimide, polyimide, and aromatic polyester. The support, when necessary, may be previously treated for ease of release, further treated with chemicals such as a silane coupling agent and titanium coupling agent, or subjected to a suitable pretreatment means such as a plasma processing, ion plating, sputtering, gas phase reaction, or vacuum deposition.

Any known method can be used for coating the support with the heat curable resin composition having a low elastic modulus. As examples of such a coating method, a dipping method, spraying method, bar coating method, roll coating method, spin coating method, curtain coating method, gravure printing method, silk screen method, or ink-jet method can be given.

The coating thickness can be suitably adjusted by controlling the method of coating and the solid concentration and viscosity of the solution of the composition.

<Cured Product of Heat Curable Resin Having a Low Elastic Modulus>

The cured product of heat curable resin having a low elastic modulus of the present invention can be obtained from the heat curable resin composition having a low elastic modulus by, for example, the following method of production. The cured product of heat curable resin having a low elastic modulus excels in stress relaxation, electrical insulation properties, heat shock, and heat resistance.

As an example of the cured product, a cured film of the heat curable resin having a low elastic modulus obtained by heat curing the above-mentioned heat curable film can be given. The cured film can be produced by coating a suitable support, which has been previously treated for ease of mold releasing, with the heat curable resin composition having a low elastic modulus to obtain a heat curable film, the heat curable film is then cured by heating, and the obtained cured film is separated from the support. The same types of support used in the previously mentioned method for producing the heat curable film can be used here. There are no restrictions to the conditions for curing the heat curable resin composition having a low elastic modulus. Depending on the use of the cured product, the composition is heated, for example, at 50-200° C. from 10 minutes to 48 hours. In order to ensure curing progresses sufficiently and to prevent generation of bubbles, curing can be conducted by heating in two stages, for example, heating at a temperature in a range of 50-100° C. from 10 minutes to 10 hours in a first stage and at a temperature in a range of 80-200° C. from 30 minutes to 12 hours in a second stage. Heating can be conducted using heating equipment such as a common oven or infrared kiln.

Since the cured product of heat curable resin having a low elastic modulus excels in stress relaxation, electrical insulation properties, heat shock, and heat resistance, a cured film of the resin composition can be used as a stress relaxation layer in electronic components such as semiconductor devices, semiconductor packages, and printed circuit boards. This stress relaxation layer also excels in electrical insulation properties, heat shock, and heat resistance.

A cured product excelling in stress relaxation properties (low stress property), electrical insulation properties, heat shock resistance, and heat resistance can be obtained using the heat curable resin composition having a low elastic modulus of the present invention.

### EXAMPLES

The present invention will now be described by way of examples, which should not be construed as limiting the present invention. In the examples and comparative examples below “parts” are indicated on a weight basis, unless otherwise specified.

The raw materials used in the Examples and Comparative Examples and the method of evaluation of the cured product will now be explained.

(A) Epoxy Resin

A-1: phenol-biphenylene glycol condensate epoxy resin (“NC-3000P” manufactured by Nippon Kayaku Co., Ltd., softening point: 53-63° C.)
A-2: phenol-naphtol/formaldehyde condensate epoxy resin (“NC-7000L” manufactured by Nippon Kayaku Co., Ltd., softening point: 83-93° C.)
A-3: o-cresol/formaldehyde condensate novolac epoxy resin (“EOCN-104S” manufactured by Nippon Kayaku Co., Ltd., softening point: 90-94° C.)
   (B) Crosslinked Fine Particles
B-1: butadiene/acrylonitrile/methacrylic acid/divinylbenzene: 75/20/2/3 (weight ratio) (Tg: −48° C.; average particle diameter: 70 nm)
B-2: butadiene/styrene/hydroxybutylmethacrylate/methacrylic acid/divinylbenzene 50/10/32/6/2 (weight ratio) (Tg: −45° C.; average particle diameter: 65 nm)
B-3: butadiene/acrylonitrile/methacrylic acid/hydroxybutylmethacrylate/divinylbenzene: 63/20/5/10/2 (weight ratio) (Tg: −40° C.; mean particle diameter: 70 nm)
   (C) Curing Agent
C-1: 2-ethylimidazole
C-2: 1-cyanoethyl-2-ethyl-4-methylimidazole
   (D) Organic Solvent
D-2: 2-heptanone
D-2: ethyl lactate
   (E) Other Resins:
E-1: phenol-xylene glycol condensate resin (“XLC-LL” manufactured by Mitsui Chemicals, Inc.)
   <Properties Evaluation Method>
   (1) Glass Transition Temperature

A resin composition was heated at 80° C. for 30 minutes and then at 150° C. for four hours to obtain a cured film with a thickness of 50 μm. The glass transition temperature (Tg) of this cured film was determined by the DSC method.

(2) Elasticity

A resin composition was heated at 800 C for 30 minutes and then at 150° C. for four hours to obtain a cured film with a thickness of 50 μm. A test specimen measuring 3 mm×20 mm (thickness: 50 μm) was taken from the cured film and the elasticity thereof was measured using the TMA method.

(3) Electrical Insulation Property (Volume Resistivity)

A SUS substrate was coated with a resin composition and heated in a convection oven at 80° C. for 30 minutes to obtain a uniform resin film with a thickness of 50 μm. The resin film was further heated at 150° C. for four hours to obtain a cured film. The cured film was subjected to a durability test using a thermohygrostat testing equipment (manufactured by ESPEC Corporation) at 85° C. and 85% humidity for 500 hours. The volume resistivity between the layers of the cured film was measured before and after the durability test.

(4) Heat Shock Resistance

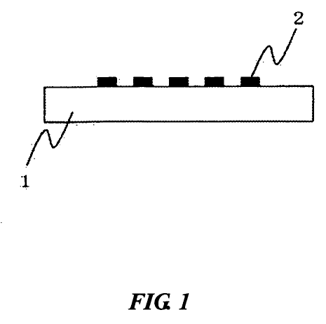

The material shown in FIG. 1 was coated with a resin composition and heated in a convection oven at 80° C. for 30 minutes to obtain a uniform resin film with a thickness of 50 μm. The resin film was further heated at 150° C. for four hours to obtain a cured film. The substrate comprising the cured film was subjected to a durability test using a heat shock chamber (“TSA-40L” manufactured by ESPEC Corporation) (one cycle: −65° C./30 minutes to 150° C./30 minutes). The number of cycles until the cured film exhibited defects such as cracking was measured.

### EXAMPLE 1

As shown in Table 1, 100 parts by weight of epoxy resin (A-1), 50 parts by weight of crosslinked fine particles (B-1), and 5 parts by weight of curing agent (C-1) were dissolved in 150 parts by weight of organic solvent (D-1). In accordance with the previously mentioned evaluation method, the glass transition temperature, electrical insulation property, heat resistance, and heat shock resistance of the cured product obtained from this solution were measured. The results are shown in Table 1.

### EXAMPLES 2-5

Cured products were prepared and evaluated in the same manner as in Example 1, except for using the compositions shown in Table 1. The results are shown in Table 1.

### COMPARATIVE EXAMPLES 1-2

Cured products were prepared and evaluated in the same manner as in Example 1, except for using the compositions shown in Table 1. The results are shown in Table 1.

TABLE 1

| | | | | | | Comparative | Comparative |
|---|---|---|---|---|---|---|---|
| | Example 1 | Example 2 | Example 3 | Example 4 | Example 5 | Example 1 | Example 2 |
| (A) Epoxy resin (parts by weight) | | | | | | | |
| A-1 | 100 | — | — | 100 | 100 | 100 | — |
| A-2 | — | 100 | — | — | — | — | 100 |
| A-3 | — | — | 100 | — | — | — | — |
| (B) Crosslinked fine particles | | | | | | | |
| (parts by weight) | | | | | | | |
| B-1 | 50 | — | — | 100 | 100 | — | 5 |
| B-2 | — | 80 | — | — | — | — | — |
| B-3 | — | — | 75 | — | — | — | — |
| (C) Curing agent (parts by weight) | | | | | | | |
| C-1 | 2 | — | 3 | — | — | 2 | — |
| C-2 | — | 4 | — | 3 | 4 | — | 4 |
| (D) Organic solvent (parts by weight) | | | | | | | |
| D-1 | 152 | 184 | — | — | — | 100 | — |
| D-2 | — | — | 178 | 203 | 234 | — | 105 |
| (E) Other resin (parts by weight) | | | | | | | |
| E-1 | — | — | — | — | 30 | — | — |
| Glass transition temperature (° C.) | 150 | 135 | 140 | 130 | 175 | 134 | 160 |
| Elasticity (GPa) | 0.6 | 0.3 | 0.5 | 0.2 | 0.5 | 3.2 | 2.8 |
| Volume resistivity (Ω · cm) | | | | | | | |
| Before test | 6 × 10¹⁵ | 3 × 10¹⁵ | 5 × 10¹⁵ | 3 × 10¹⁵ | 3 × 10¹⁵ | 7 × 10¹⁵ | 5 × 10¹⁵ |
| After test | 8 × 10¹⁴ | 5 × 10¹⁴ | 7 × 10¹⁴ | 4 × 10¹⁴ | 4 × 10¹⁴ | 5 × 10¹⁴ | 8 × 10¹⁴ |
| Heat shock resistance (no. of cycles) | 1000 | 1000 | 1000 | 1000 | 1000 | 200 | 300 |

A highly reliable circuit board free from cracking resulting from heat related stress, disconnections, and the like can be obtained by using the heat curable resin composition having a low elastic modulus and the cured product thereof of the present invention as an interlayer dielectric in a multilayer circuit board or the like.

What is claimed is:

1. A heat curable resin composition having a low elastic modulus comprising (A) an epoxy resin, (B) crosslinked fine particles, and (C) a curing agent, which, when cured with heat, can produce a cured product with elastic modulus of less than 1 GPa.

2. The heat curable resin composition according to claim 1, wherein the epoxy resin (A) is selected from the group consisting of bisphenol A epoxy resin, bisphenol F epoxy resin, hydrogenated bisphenol A epoxy resin, hydrogenated bisphenol F epoxy resin, bisphenol S epoxy resin, brominated bisphenol A epoxy resin, biphenyl epoxy resin, naphthalene epoxy resin, fluorene epoxy resin, spirocyclic epoxy resin, bisphenol alkane epoxy resin, phenol novolak epoxy resin, o-cresol novolak epoxy resin, brominated cresol novolak epoxy resin, trishydroxymethane epoxy resin, tetraphenylolethane epoxy resin, aliphatic epoxy resin, alcohol epoxy resin, butyl glycidyl ether resin, phenyl glycidyl ether resin, cresyl glycidyl ether resin, nonyl glycidyl ether resin, diethylene glycol diglycidyl ether resin, polyethylene glycol diglycidyl ether resin, polypropylene glycol diglycidyl ether resin, glycerol polyglycidyl ether resin, neopentyl glycol diglycidyl ether resin, 1,6-hexanediol diglycidyl ether resin, trimethylolpropane triglycidyl ether resin, hexahydrophthalic acid diglycidyl ether resin, fatty acid modified epoxy resin, toluidine epoxy resin, aniline epoxy resin, aminophenol epoxy, 1,3-bis(N,N-diglycidylaminomethyl)cyclohexane resin, hydantoin epoxy resin, triglycidylisocyanurate resin, tetraglycidyldiaminodiphenylmethane resin, diphenyl ether epoxy resin, dicyclopentadiene epoxy resin, dimmer acid diglycidyl ester resin, hexahydrophthalic acid diglycidyl ester resin, dimmer acid diglycidyl ether resin, silicone-modified epoxy resin, silicon-containing epoxy resin, urethane-modified epoxy resin, NBR-modified epoxy resin, CTBN-modified epoxy resin, and epoxidated polybutadiene resin.

3. The heat curable resin composition according to claim 1, wherein the crosslinked fine particles (B) have a single glass transition temperature within a range from −100° C. to 0° C.

4. The heat curable resin composition according to claim 1, wherein the crosslinked fine particles (B) are made of a copolymer of a crosslinkable monomer having at least two polymerizable unsaturated bonds and a monomer other than the crosslinkable monomer which is selected from monomers that can produce a copolymer with a Tg of between −100° C. and 0° C.

5. The heat curable resin composition according to claim 4, wherein the crosslinkable monomer having at least two polymerizable unsaturated bonds is selected from the group consisting of divinylbenzene, diallyl phthalate, ethylene glycol di(meth)acrylate, propylene glycol di(meth)acrylate, trimethylolpropane tri(meth)acrylate, pentaerythritol tri(meth)acrylate, polyethylene glycol di(meth)acrylate, and polypropylene glycol di(meth)acrylate.

6. The heat curable resin composition according to claim 4, wherein the monomer other than the crosslinkable monomer is selected from the group consisting of vinyl compounds, unsaturated nitrile compounds, unsaturated amides, (meth)acrylic acid esters, aromatic vinyl compounds, epoxy (meth)acrylates obtained by the reaction of diglycidyl ether of bisphenol A or diglycidyl ether of glycol with (meth)acrylic acid, or hydroxy alkyl(meth)acrylate, urethane (meth)acrylates obtained by the reaction of hydroxy alkyl (meth)acrylate with polyisocyanate, epoxy group-containing unsaturated compounds, unsaturated acid compounds, amino group-containing unsaturated compounds, amide group-containing unsaturated compounds, hydroxyl group-containing unsaturated compounds, hydroxypropyl (meth)acrylate, and hydroxybutyl (meth)acrylate.

7. The heat curable resin composition according to claim 1, wherein the amount of the crosslinked fine particles (B) is 50 parts by weight or more for 100 parts by weight of the epoxy resin (A).

8. The heat curable resin composition according to claim 1, wherein the curing agent (C) is selected from the group consisting of amines, carboxylic acids, acid anhydrides, dicyandiamides, dibasic acid dihydrazide, imidazoles, organic boron, organic phosphine, and guanidines.

9. The heat curable resin composition according to claim 1, wherein the amount of the curing agent (C) is 0.1-20 parts by weight for 100 parts by weight of the epoxy resin (A).

10. A heat curable film made from the heat curable resin composition of claim 1.

11. A cured product obtained by heat curing the heat curable resin composition of claim 1.

12. An electronic component comprising a stress relaxation layer obtained from the heat curable resin composition of claim 1.
